(19) United States
(12) Patent Application Publication
(10) Pub. No.: US 2024/0272513 A1
(43) Pub. Date: Aug. 15, 2024

(54) INTEGRATED OPTICAL PHASED ARRAY

(71) Applicant: Danmarks Tekniske Universitet, Kongens Lyngby (DK)

(72) Inventors: Yong Liu, Kongens Lyngby (DK); Hao Hu, Kongens Lyngby (DK)

(21) Appl. No.: 18/569,460

(22) PCT Filed: Jun. 30, 2022
(86) PCT No.: PCT/EP2022/068129

§ 371 Date: Dec. 12, 2023

(30) Foreign Application Priority Data
Jul. 1, 2021 (EP) 21183249.8
Feb. 15, 2022 (EP) 22156803.3

(51) Int. Cl. G02F 1/295; G02F 1/29

(52) U.S. Cl. CPC G02F 1/2955; G02F 1/292; G02F 2203/11

(57) ABSTRACT

The present disclosure relates to an integrated optical phased array (OPA) with a large field of view (FOV), possibly up to 180 degrees FOV. One embodiment regards a chip integrated optical phased array, comprising: a phase shifter array having N input light channels and configured for tuning the phase of the N input light channels; a beam splitter configured for splitting light from a light source into the N input channels of the phase shifter array; a waveguide array configured for squeezing the phase tuned N light channels to a narrow pitch output end such that the light form N channels interfere to form a plane wave at the output end; and a plane emitting surface configured for transforming the plane wave to light emittance out of the chip with a predefined field of view (FOV). Another embodiment regards an OPA with an on-chip beam expander for small beam divergence with a relatively low number of channels.

### CROSS REFERENCE TO RELATED APPLICATION

This application claims priority from European Patent Application No. 21183249.8 filed Jul. 1, 2021 and entitled INTEGRATED OPTICAL PHASED ARRAY WITH LARGE FIELD OF VIEW; and European Patent Application No. 22156803.3 filed Feb. 15, 2022 and entitled INTEGRATED OPTICAL PHASED ARRAY WITH LARGE FIELD OF VIEW, both of which are incorporated herein in their entirety by reference.

### TECHNICAL FIELD

The present disclosure relates to an integrated optical phased array (OPA) with a large field of view (FOV), possibly up to 180 degrees FOV, and/or with a small beam divergence, possibly down to 0.01 Degrees.

### BACKGROUND

Radio frequency (RF) phased array was first proposed more than a century ago and has been widely used for radar and wireless communications. Infrared and visible light, the electromagnetic waves at optical frequencies, has a wavelength of three to five orders of magnitude shorter than that of the radio wave, thus optical phased array (OPA) could offer much higher precision than the RF phased array. Chip-scale OPA which can quickly and precisely steer light in a non-mechanical way, represents a new enabling technology for compact solid-state two-dimensional (2D) beam steering as an alternative to traditional mechanical beam steering such as microelectromechanical systems (MEMS), which, due to their mechanical properties, suffer heavily from vibrations.

The chip-scale OPA opens a promising path for solid-state light detection and ranging (LiDAR) system, which has a wide range of applications, such as autonomous vehicles, holography, augmented and virtual reality, biological imaging and free-space optical communications. However, prior art OPA technology remain limited in FOV and beam quality due to unwanted grating lobes and side lobes.

### SUMMARY

A conventional phased array consists of arrays of coherent emitters and a desired far-field radiation pattern can be formed and steered through the interference of the emissions by controlling the phase of each emitter. If the emitter spacing is half wavelength or less, 180° FOV can theoretically be achieved and grating lobes can be avoided. If the emitter spacing is larger than half wavelength, strong constructive interference occurs at multiple far-field angles and grating lobes are generated, which causes aliasing and limits the FOV. Aliasing-free 2D beam steering with a large field of view (FOV) and high beam quality is beneficial for most of the applications.

Half-wavelength spacing has been achieved in RF phased arrays due to strong confinement in metals, but metals are extremely lossy for optical frequencies. Dielectric waveguides are used to confine the light in the OPAs, but the emitting planar waveguides (or waveguide gratings) cannot be spaced half-wavelength or less since this causes uncontrollable strong evanescent coupling between emitters. The OPAs based on edge-emitting (end-fire) array, where light emits into free space at the edge of the device, have achieved half-wavelength spacing and a large FOV. However, the beam of the end-fire OPAs is a stripe rather than a spot, which can only be steered in one dimension. A non-uniform spacing (pitch) between adjacent emitters can avoid constructive interference and suppress grating lobes. However, this approach does not increase the power in the main beam and only redistributes the power of grating lobes into a wider range of angles, resulting in increased background noise.

For many applications it is important that the OPA has a very small beam divergence, preferably of 0.01 Degrees. A small beam divergence is beneficial when, for example, OPAs are used for LiDAR in automotive applications where a light beam has to travel considerable distances and a large beam divergence prevents, for example, detection of small-size objects such as pedestrians on a road.

The present disclosure relates to integrated optical phased array, e.g. integrated in a chip, comprising:
a phase shifter array having N input light channels, preferably configured for tuning the phase of the N input light channels,
a beam splitter configured for splitting light from a light source into the N input channels of the phase shifter array;
at least one waveguide array configured for squeezing the phase tuned N light channels to at least one output end, such that the N light channels may interfere and preferably form a first plane wave at the output end; and
an emitter configured for emitting light out of the chip with a predefined field of view (FOV) and/or with a predefined beam divergence.

In one embodiment of the present disclosure the at least one output end has a narrow pitch. For example the at least one output end has a pitch of less than one wavelength of the light, preferably between 0.8 and 0.3 of the wavelength of the light, more preferably between 0.55 and 0.45 of the wavelength of the light, most preferably around half the wavelength of the light. In particular, in one embodiment of the present disclosure the pitch of the output end is such that a 180 degrees field of view of the OPA may be obtained.

In one embodiment of the present disclosure, the emitter is a plane emitting surface, such as a plate grating, or a slab grating and is configured for transforming the first plane wave to light emittance out of the chip, preferably with a predefined field of view (FOV) and/or with a predefined beam divergence.

In one embodiment of the present disclosure, the number of channels N of the phase array is at least 4, more preferably at least 8, even more preferably at least 32, most preferably at least 64.

The present inventors have realized that, in conventional OPA schemes, with, for example, waveguide gratings emitters, background noise is generated by the inconformity of field pattern from the emitting elements. For example, in the waveguide grating based OPA, because of the imperfection of the waveguides fabrication, the sidewall roughness induced scattering makes each emission of the waveguide grating different. To tackle this issue, the present inventors have realized that, instead of using separate waveguide grating emitters, an out-of-box emitting surface such as a plane emitting surface, or a plate grating or a slab grating may be used. The emitter of the presently disclosed OPA, such as a plane emitting surface, for example a plate grating or a slab grating, eliminates the concept of emitting elements array and emits the light from a single surface which completely solves the inconformity issue.

The presently disclosed optical phased array (OPA) is fundamentally different from the conventional OPA based on waveguide grating array as the emitter. A waveguide grating solution suffers heavily from cross-talk especially when the pitch of the waveguide grating is small. Due to crosstalk waveguide grating based OPAs cannot achieve a full 180 degrees field of view.

In one embodiment of the presently disclosed OPA, the emitter is a plane emitting surface configured for transforming the plane wave to light emittance out of the chip with a predefined field of view (FOV).

When all element factors of all channels are the same, the far field pattern may be expressed according to the following equation:

$$U ( {θ}_{x} , {θ}_{y} ) = \frac{1}{\sqrt{N}} E ( {θ}_{x} , {θ}_{y} ) \cdot {\sum }_{n = 0}^{n = N - 1} {A}_{n} {e}^{j \frac{2 π}{λ} n d s i n {θ}_{y} + jn Δφ}$$

Where E(θₓ, θ_{y}) is the element factor equal for each channel and

$${\sum }_{n = 0}^{n = N - 1} {A}_{n} {e}^{j \frac{2 π}{λ} n d s i n {θ}_{y} + jn Δφ}$$

is the array factor.

In case of emitter grating array as in prior art, the cross-talk effect within the channels is affecting the element factor of the different channels and is making the element factor different from channel to channel, generating side lobes.

The present inventors have realized that this may be overcome by using a large plane emitting surface, such as a grating surface. If the plane emitting surface is large enough in the direction perpendicular to the direction of the waveguide array, the interaction of the light from the most external waveguides and the boundary of the plane emitting surface is negligible or is substantially the same as the interaction from the central waveguides of the array and the boundary of the plane emitting surface. Therefore, in the present disclosure, the element factor of each channel may be the same, the transitional symmetry is not broken and there may be no significant side lobes and therefore a large field of view may be achieved.

The present inventors have realised that the inability of conventional OPA based on waveguide grating array to achieve 180 degree field of view is due to the breakdown of the transitional symmetry of each element along the array direction since there is strong crosstalk or coupling between emitters when the pitch of the emitters decreases such as wavelength spacing or half-wavelength spacing. According to the antenna theory, only when each emitting element shares the same element factor can the far field be expressed as the product of the element factor and array factor. The breakdown of transitional symmetry leads to different element factors of each element and further leads to the malfunction of the OPA device.

For the presently disclosed OPA, each element comprises or consists of a waveguide in the waveguide array and the shared plane emitting surface. The plane emitting surface, for example the plate grating or slab grating is not confined in the direction perpendicular to the waveguide array (the array direction). The plane emitting surface is sufficiently long in the direction perpendicular to the waveguide array. In theory, the light emitted from any of the waveguides in the array doesn't interact or has negligible interaction with the boundary of the plane emitting surface on the chip plane. So each element (each waveguide in the waveguide array and the shared plane emitting surface) in the array has transitional symmetry along the array direction. Even if the pitch of the waveguide array decreases down to less than half-wavelength, the crosstalk or coupling between waveguides doesn't affects the transitional symmetry because it only exists in a short distance and may be eliminated by techniques such as introduced phase mismatching between waveguides.

In the presently disclosed OPA, the crosstalk or coupling between the waveguide array may also be eliminated by a combination of phase modulation and amplitude modulation. It may be achieved by adding an amplitude modulator in each channel of the OPA device.

In the presently disclosed OPA, the working wavelength is not limited to a specific wavelength range but can range from ultraviolet light, visible light, near infrared light, mid-infrared light to far infrared light.

In the presently disclosed OPA, the material platform of the device is not limited to silicon platform but can also be indium phosphide, silicon nitride, silicon oxide, aluminum nitride or any material platform on which OPA device may be fabricated.

In one embodiment of the presently disclosed OPA, the emitter is a plane emitting surface configured for transforming the plane wave to light emittance out of the chip with a predefined field of view (FOV).

In one embodiment of the presently disclosed OPA, the total length of the waveguide array may be kept short, minimizing crosstalk between the channels, or the waveguides, and allowing a narrow pitch in the waveguide array, such as half wavelength. A half wavelength pitch of the waveguide array allows subsequently a 180 Degrees field of view, according to far field theory. In the presently disclosed OPA the field of view may not limited by the crosstalk in the waveguide array, as the waveguide array is kept short because it does not comprise a waveguide grating array. In the presently disclosed OPA, the light from a short waveguide array may interfere at an output end of the waveguide array, forming a plane wave with a near field angle directed to a single emitter. The plane wave is subsequently weakly diffracted and brought out of the chip by a single emitter, such as a plate or slab grating, with a magnified angle, and a 180 degrees field of view may be achieved. The full field of view of the presently disclosed OPA may be in summary achieved by a combination of the following: use waveguide array with a small pitch such as half a wavelength, and the length of the waveguide array should be is as short as possible to minimize crosstalk within the waveguide array; and use of a single emitter configured to emit an on-chip plane wave, formed at the output end of the waveguide array, out of the chip to the far field. In addition, in one embodiment of the presently disclosed OPA, a Gaussian or non-uniform amplitude distribution of the light among all the channels, contributes to supress side lobes and achieves a very good and/or high side lobe (SLL) suppression.

In another embodiment of the presently disclosed OPA, the pitch of the waveguide array may be non-uniform, which still results in a 180 degrees field of view, but with a higher background noise.

A major advantage of the presently disclosed OPA is that it can be fabricated on a chip, e.g. silicon on insulator (SOI) chip. The fabrication of the chip can be fully compatible with complementary metal-oxide-semiconductor (CMOS) process, such that the presently disclosed OPA can be made very compact and can be manufactured reliably and cost-efficient, or at low cost and at a large volume.

The present inventors have realized that, for achieving a small beam divergence, the number of channels of the OPA has to be increased. For very good beam divergences of about 0.01 degrees the required number of channels is often more than one thousand. The large number of channels is a problem when manufacturing and when packaging the OPA. For example an OPA with a large number of channels requires thousands of bonding wires when being packed on a board, or it requires other advanced bonding techniques such as flip chip, which makes it expensive and complicated. The inventors have realized that it would be advantageous to obtain a small beam divergence without increasing the number of channels, and having it limited less than 1000, preferably less than or equal to 100, more preferably less than or equal to 64, even more preferably less than or equal to 32.

In one embodiment, the presently disclosed OPA further comprises a beam expander configured to expand the first plane wave to a second expanded plane wave, and the emitter, such as a plate or slab grate or grating, is further configured for transforming the second expanded wave to light emittance with a predefined beam divergence.

The inventors have realized that, by including a beam expander between the waveguide arrays and the emitter, the beam divergence can be reduced without increasing the number of channels.

For a previous design, without beam expander, the beam divergence can be calculated according to the following equation:

$$θ = \frac{0.886 * λ}{{N}_{wo expans \dot{ι} o n} d}$$

where θ is the beam divergence, λ is the wavelength of the light, d is the pitch at the output end of the waveguide array and N_{wo expansion} or N is the number of channels that would be needed without beam expansion. On the contrary, the following equation can be used to calculate the required number channels when using beam expansion between a waveguide array and the emitter, with an expansion ratio α:

$$N = {N}_{w expansion} = \frac{{N}_{wo expansion}}{α}$$

where N_{wo expansion} is the number of channels required for a given beam divergence without beam expansion, and N=N_{w expansion} is the number of channels required for a given beam divergence with beam expansion. It is clear from the equation above that the number of channels can be reduced by using an expansion ratio greater than one.

The present disclosure further relates to a method for generating a two-dimensional (2D) spot light beam with a 180 Degrees horizontal field of view (FOV), the method comprising the steps of:
providing input light, preferably with a wavelength between 1480 nm and 1580 nm, within a chip;
splitting the input light into N light channels in a phase shifter array in the chip;
squeezing the N light channels into a waveguide array with a predefined pitch on the chip;
converging the lights from the N channel to a plane wave in proximity of an end of the waveguide array; and
emitting light out of the chip, for example by means of a plane emitting surface., wherein the emitting angle in one direction or dimension of the emitted light is controlled by adjusting the phase in each light channel.

According to this method, the input light is provided with a tunable wavelength, for example with a wavelength between 1480 nm and 1580 nm, coupled into the chip. The wavelength is not limited to this range and can range from ultraviolet light, visible light, near infrared light, mid-infrared light to far infrared light;

An advantage of such a method is that the emitting angle in one direction of the emitted light can be controlled by adjusting the phase in each light channel. The wavelength of the input light can be further tuned to control the other direction of the emitted light and to obtain a 2D beam.

The presently disclosed method can be realized by means of the presently disclosed optical phased array.

The present disclosure further relates to a method for operating an integrated optical phased (OPA) array with a predefined beam divergence, the OPA comprising:
a phase shifter array having N input light channels and comprising the shifter array configured for tuning the phase of the N input light channels;
one or more waveguide arrays, for generating a first plane wave at an output end of one of the waveguide arrays;
a beam splitter configured for splitting light from a light source into the N input channels of the phase shifter array,
a beam expander configured to expand the first plane wave to a second expanded wave; and
an emitter configured for transforming or emitting the second expanded wave to light emittance with a predefined beam divergence;

the method comprising the steps of:
providing a light source as an input to the beam splitter;
providing a target emission angle in a far field;
based on said target emission angle, calculating an output angle of the second expanded wave;
based on said output angle, calculating an injection angle of the first planar wave;
selecting and or controlling phase shifts in the phase shifter providing a first component of the calculated injection angle;
selecting one waveguide array providing a second component of the calculated injection angle.

The present disclosure further relates to a method for reducing the number of channels of an integrated phased array (OPA) with beam expansion as herein disclosed, with a predefined beam divergence θ, the method comprising the steps of:
Providing a target beam divergence θ;
Identifying the required wavelength λ and a pitch of a selected waveguide array output end d;
Calculating the required number of channels N_{wo expansion} without beam expansion according to the following equation

$$θ = \frac{λ}{{N}_{wo expans \dot{ι} o n} d} ,$$

where d is the pitch between the channels;
Calculating the required beam expansion ratio a to obtain the desired number of channels N according to the equation

$$N = {N}_{w expansion} = \frac{{N}_{wo expans \dot{ι} o n}}{α} ;$$

Designing the beam expander with the required expansion ratio according to the present disclosure.

### DESCRIPTION OF THE DRAWINGS

The present disclosure will in the following be described in greater detail with reference to the accompanying drawings. The drawings are exemplary and are intended to illustrate some of the features of the presently disclosed optical phased array (OPA) and method for generating a two-dimensional beam, and are not to be construed as limiting to the presently disclosed invention.

FIG. 1 is a schematic view of an embodiment of the presently disclosed OPA.

FIG. 2 is a schematic view of a further embodiment of the presently disclosed OPA.

FIG. 3 is a schematic diagram of the waveguide array. The waveguides in the waveguide array have different widths when the pitch is narrow (104) but at the output end the waveguides are tapered (111) to the same width (112).

FIG. 4 is a crosstalk diagram between adjacent waveguides in the waveguide array with different widths.

FIG. 5 is an image of one embodiment of the presently disclosed OPA.

FIG. 6 is a diagram representing the far-field optical power of one embodiment of the presently disclosed OPA as a function of the horizontal emitting angle.

FIG. 7 is a diagram representing the side lobe level (SLL) in dB, in blue, of one embodiment of the presently disclosed OPA as a function of the horizontal emitting angle and the beam divergence, in red, as a function of the horizontal emitting angle.

FIG. 8 is a two-dimensional (2D) image obtained by one embodiment of the presently disclosed OPA, achieved at different horizontal angles obtained by tuning the phase of the phase shifter array, and at different vertical angles, obtained by modulation of the wavelength of the light.

FIG. 9 is a diagram showing the filtering of high order diffraction beams by use of a free propagation region and a trapezoidal emitting surface.

FIG. 10 is a main steps of one of the presently disclosed methods.

FIG. 11 shows a measurement setup.

FIG. 12 shows the spliced image of the measured far-field radiation pattern as a function of the angle in the horizontal direction. The trajectory is a curve since the imaging system rotates along a circular rail.

FIG. 13 shows an embodiment of the presently disclosed OPA with a beam expander (500).

FIG. 14 shows an embodiment of the presently disclosed OPA with a lens-based beam expander.

FIG. 15 shows three embodiments of a lens used for beam expansion for the presently disclosed OPA.

FIG. 16 shows an embodiment of the presently disclosed OPA, wherein the beam expander is implemented as an on-chip grating surface (600).

FIG. 17 shows a schematic diagram of an embodiment of the presently disclosed OPA, wherein the beam expander (600) comprises a grating surface and wherein the OPA comprises one waveguide array (104) and an emitter (107), such as an emitting surface.

FIG. 18 shows a schematic diagram of an embodiment of the presently disclosed OPA, wherein the beam expander (600) comprises a grated surface and wherein the OPA comprises two waveguide arrays (104-A and 104-B) and an emitter (107), such as an emitting surface. In this embodiment the grated surface beam expander comprises two gratings with different grating angles.

FIG. 19 shows a schematic diagram of an embodiment of the presently disclosed OPA, wherein the beam expander (600) comprises a grated surface and wherein the OPA comprises two waveguide arrays (104-A and 104-B) and an emitter (107), such as an emitting surface. In this embodiment the grated surface beam expander comprises two gratings with different grating angles. In this embodiment the orientation of the waveguide arrays is different as compared to the embodiment shown in FIG. 18.

FIG. 20 shows the coupling strength of a grated surface beam expander according to one embodiment of the presently disclosed OPA.

FIG. 21 shows a block diagram of one embodiment of one of the presently disclosed methods, the method to design an OPA according to the present disclosure for obtaining a predefined beam divergence.

FIG. 22 shows a schematic diagram of an embodiment of the presently disclosed beam expander in OPA. It is a two-dimensional photonics crystals consisting of holes or pillars. In one dimension the spacing or pitch of the holes or pillars is uniform, while in the other dimension it is non-uniform.

FIG. 23 shows a schematic diagram of an embodiment of the presently disclosed beam expander in OPA. It is a two-dimensional photonics crystals consisting of holes or pillars. The spacing or pitch of the holes or pillars are uniform in both dimensions, but it is much larger in one dimension than the other.

FIG. 24 shows a comparison (800) of an obtained beam divergence or spot size of an embodiment of the presently disclosed OPA, with beam expansion (802) according to an embodiment of the present disclosure and without beam expansion (801).

### DETAILED DESCRIPTION

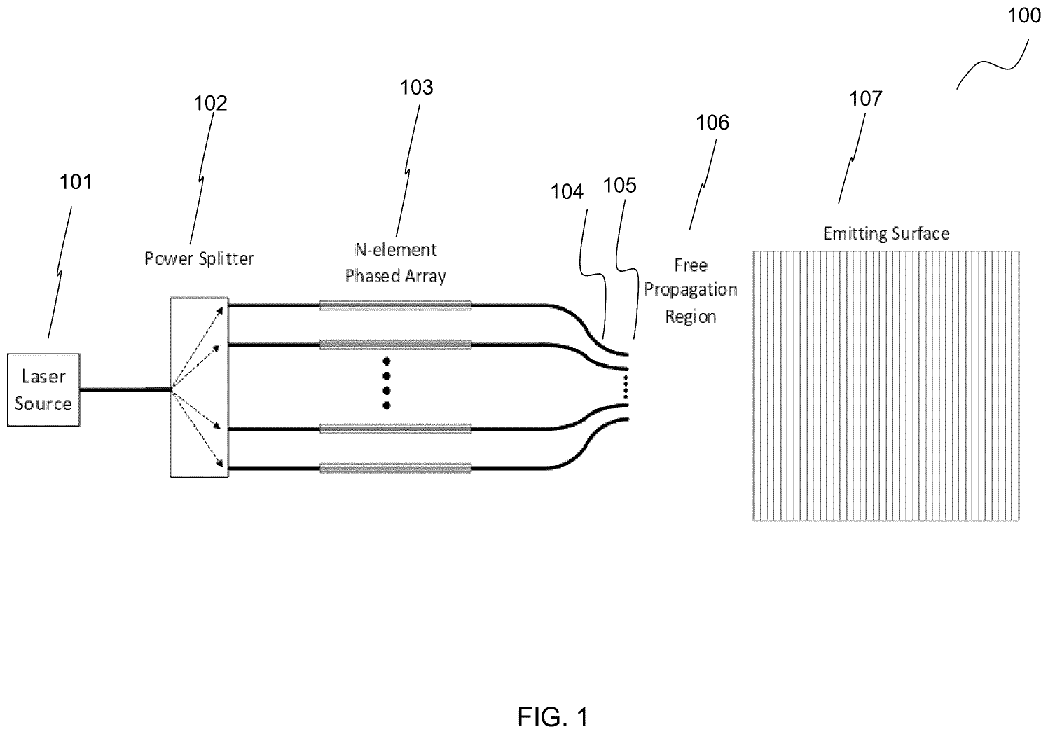

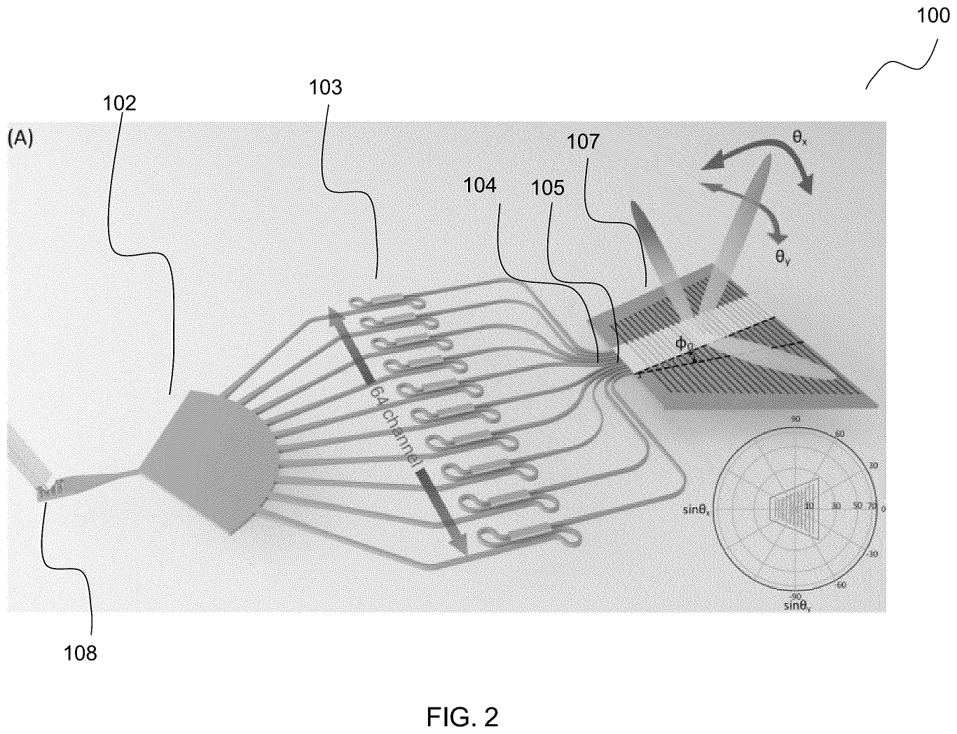

FIG. 1 shows a schematic diagram of one embodiment of the presently disclosed optical phased array (OPA) (100). As seen from the figure, input light is provided by a Laser source (101), which may be an on chip light source or external source coupled in to the chip, and is split by a power splitter (102). The power splitter (102) splits the light, preferably accordingly to a Gaussian distribution, into N channels of the phase shifter array (103) or N-element Phased Array. The Gaussian, or non uniform amplitude distribution contributes to supress side lobes and achieves a low side lobe level (SLL). Each channel in the phase shifter array is phase shifted by a programmable phase shifter array (103). The phase shift is controlled by a controller (not shown in the figure) and the phase shifter array may be a thermo-optical, MEMS or electro-optical or other types of phased shifter array. The N channels from the phase shifter array are then squeezed into a waveguide array (104) with a narrow pitch output end (105). The narrow pitch can enable a large field of view. The pitch of the waveguide array is preferably half wavelength, in order to achieve 180 degrees FOV. The length of the waveguide array depends on the number of channels and is longer for larger number of channels due to the physical curvature of the bended waveguides, but it is kept to a minimum and, in case of an OPA embodiment of 64 channels is 52 micrometers, for an OPA embodiment of 1000 channels is 700 micrometers, and in all cases is such that the crosstalk between the channels is minimized by varying the width of the waveguide array and allows 180 Degrees FOV. Reducing the crosstalk may be achieved by varying the width of the waveguide array or other methods to introduce phase mismatching between the waveguides. At the end of the waveguide array, the widths are tapered to be same to suppress the side lobes. In the embodiment shown in FIG. 1 the OPA has an optional free propagation region. The free propagation region is optional, and, as an example, is not shown in the embodiment of FIG. 2. The light from the N-channels waveguide array (104) interferes at the narrow pitch output end (105) of the waveguide array (104) and forms a plane wave directed to the emitter or emitting surface (107). The emitting surface (107) may be a plate grating with weak diffracting properties and emits the planar wave out of the chip with a 180 degrees field of view.

In embodiments where the light source is an external light source, a taper, inverse taper, grating coupler, or lens may be used to connect the external source to the chip.

FIG. 2 is showing a further embodiment of the presently disclosed OPA. The light from the light source is launched into the chip via a coupler (108) such as an apodized grating coupler, and then split into N channels by the 1-to-N beam splitter (102). After being phase shifted, the light from the N channels of the phase shifter array is squeezed in the waveguide array (104) and then reaches the narrow pitch output end (105) of the waveguide array, where as a result of interference, a planar wave is formed and directed to the emitting surface (107). In this embodiment, the free propagation region is not present. In this embodiment the emitting surface is a trapezoidal plane grating.

### General Features

The optical phased array of the present disclosure may be integrated on a chip, which may be a silicon on insulator (SOI) chip and the fabrication of the chip is fully compatible with complementary metal-oxide-semiconductor (CMOS) process.

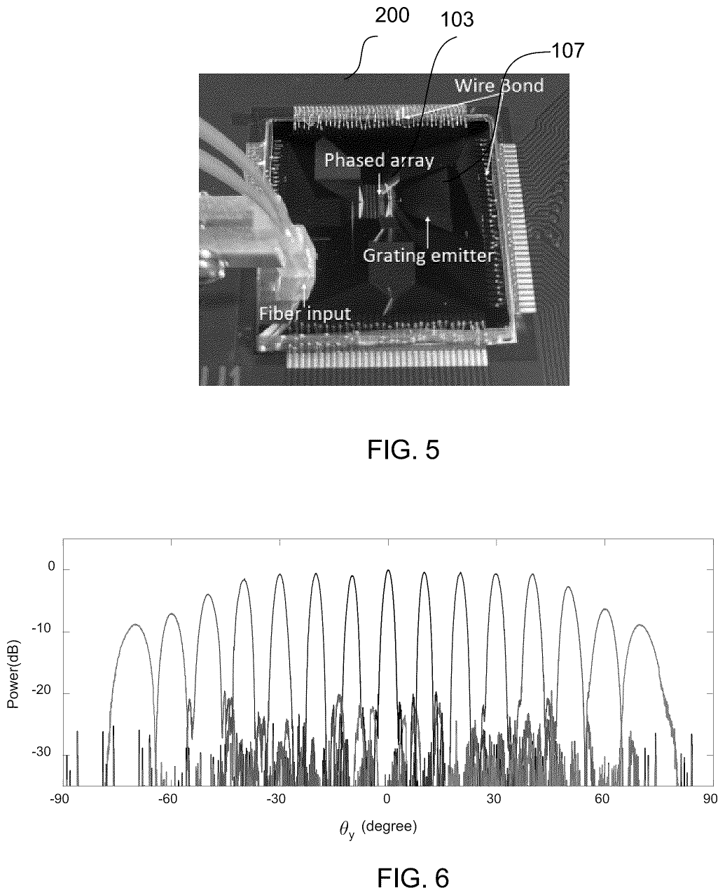

The chip based integrated optical phase array may be mounted on a printed circuit board (PCB). FIG. 5 shows the OPA chip mounted on a PCB and connected to the PCB with bonding wires.

The optical phased array of the present disclosure may have a number of channels N of the phase array, wherein said number of channels is at least 4, more preferably at least 8, even more preferably at least 32, most preferably at least 64.

In one embodiment of the presently disclosed OPA the number of channel is 64.

In a further embodiment of the presently disclosed OPA the number of channels is 1000 or more.

In a further embodiment of the presently disclosed OPA the number of channels may be 8000 or more and is typically limited by fabrication process limitations.

One embodiment of the presently disclosed OPA may have an achieved crosstalk figure, in case of 64 channels, of −19 dB. This low crosstalk is due to the fact that these channels have a Gaussian amplitude distribution and the crosstalk between the channels is minimized.

One embodiment of the presently disclosed OPA comprises a coupler, such as an apodized grating coupler, for coupling light from a light source into the OPA chip, and wherein the coupler preferably is integrated on the chip.

In one embodiment of the presently disclosed OPA, the wavelength of the light is between 1480 nm and 1680 nm, such as 1550 nm, or other wavelengths relevant to optical phased arrays, such as visible light, near-infrared or mid-infrared light. This tunable range of wavelengths is used, in the presently disclosed OPA, to achieve a two-dimensional (2D) beam. In the presently disclosed OPA, the angle in the horizontal direction is tuned by tuning the phase shifts of the light in the N channels in the phase shifter array and the angle in another, such as vertical, direction is achieved by tuning the wavelength of the emitting light which is then diffracted at a different angle in the other direction by the fixed pitch of the emitter (plate grating)

One embodiment of the presently disclosed OPA may have an achieved field of view (FOV) of 180 degrees in the horizontal direction, corresponding to an angle comprised between −90 Degrees and +90 degrees. The full field of view of 180 degrees of the presently disclosed OPA may be achieved by a combination of the following: use of a half wavelength pitch waveguide array, which is as short as possible to minimize crosstalk within the waveguide array; and use of a single emitter configured to emit an on-chip plane wave, formed at the output end of the waveguide array, out of the chip to the far field. In addition a Gaussian distribution of the amplitudes in the N channels contributes to a low side lobe level.

### Beam Splitter

In a further embodiment of the presently disclosed application, the beam splitter is a 1-to-N splitter, such as a star coupler, or a Y branch array, or a cascaded directional coupler or a Multimode Interference splitter.

Poor side lobe level (SLL) in prior art OPAs is often a limiting factor. In addition, conventional OPAs with uniform emission (uniform distribution of the power across the N channels) results in a sinc² pattern in far field with a theoretical minimum (side lobe level) SLL of −13.26 dB. The present inventors have realized that a significant suppression of the side lobe level can be achieved by using a Gaussian amplitude distribution of the light in the N channels of the phase shifter array.

In one embodiment, the disclosed chip-based integrated optical phased array simultaneously achieves aliasing-free beam steering over the entire 1800 field of view (FOV) and a high-quality beam with a low side lobe level (SLL).

In one embodiment of the presently disclosed OPA, the beam splitter is configured to split the light into N channels according to a Gaussian Amplitude Distribution (GAD) of the light in the N channels, and wherein the center-to-edge GAD ratio preferably is at least 5 dB, more preferably at least 7.5 dB, or set by a requirement of the side lobe level (SLL).

In the presently disclosed OPA, the Gaussian distribution, or non-uniform distribution of the amplitudes in the N channels may avoid abrupt drop of the field intensity and avoid the rise of side lobes in the far field. The present inventors have realized that, with a center-to-edge GAD ratio of 7.5 dB a theoretical side lobe level (SLL) of −30 dB can be achieved.

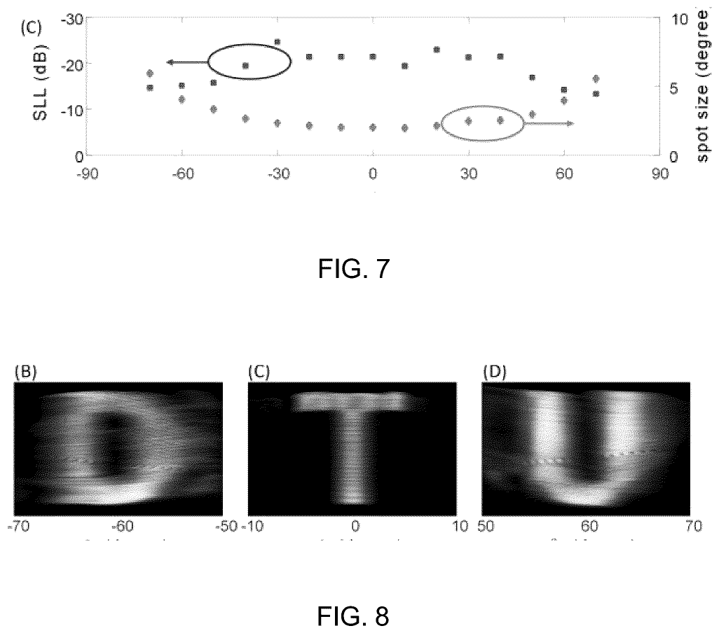

In one embodiment of the presently disclosed OPA, the achieved side lobe level (SLL) may be −19 dB for the case of N=64 channels when the beam is steered within a ±40 degrees range, and the achieved SLL is −13.2 dB when the beam is steered at a ±70 degrees range. That is shown in FIG. 7, where the blue dots show the SLL in dB as a function of the horizontal angle.

In one embodiment, a distribution of the amplitudes in the beam splitter may be Gaussian or other distribution, and may result in a very good or high Side-Mode-Suppression-Ratio (SMSR), or side lobe suppression ratio. For example, in case of Gaussian distribution in the beam splitter, the resulting spot in the far field may have a very good, or very high SMSR and/or side lobe suppression ratio of about 30 dB.

In a further embodiment of the presently disclosed application, a uniform or a non-uniform amplitude distribution of the light in the N light channels of the phase shifter array is applied by designing of the beam splitter.

The present inventors have realized that, in traditional OPA schemes based on waveguide gratings emitters, background noise is generated by the amplitude distribution of the emitting elements on the edge where there is an abrupt drop of the field intensity, which results in the rise of side lobes according to far field theory.

To tackle the above mentioned issue the present inventors have realized that a non-uniform amplitude distribution, such as a Gaussian distribution with, for example, 7.5 dB amplitude drop from center-to-edge, may be used in the beam splitter, efficiently suppressing the side lobes with a high resulting SMSR, or a low side lobe level, of −30 dB.

In one embodiment, the presently disclosed OPA has a Gaussian amplitude distribution (GAD) along the channels and achieve the SLL of <−19 dB, when the beam is steered from −40° to +40°.

### Phase Shifter Array

In the presently disclosed optical phased array the input channels of the phase shifter array may be folded waveguides having variable widths and a pitch, preferably between 0.775 micrometers, such as substantially half wavelength, and 2 micrometers.

In one embodiment of the present disclosure, the phased shifter array may be a thermo-optical phased array, or any type of phase tuner, such as heater-based tuner, electro-optical modulator, or MEMS based phase tuner, and may be configured to shift the phase of each light channel independently.

In one embodiment of this disclosure, a first channel of the N channels may be phase-shifted by a phase shift of Δφ and the N^{th} channel may be phase-shifted by N Ap.

In a further embodiment of this disclosure, the channels of the N channels may be phase shifted according to a required horizontal angle in the far field and in order to obtain arbitrary beam pattern forming and dynamic beam steering in the far field.

In one embodiment of the present disclosure, each channel of the phased shifter array is controlled by a controller, such as a digital-to-analog converter (DAC) or a field programmable gate array (FPGA), configured for allowing arbitrary phase shifts from 0 to 2π radians for each channel.

### Waveguide Array

In one embodiment, the presently disclosed optical phased array OPA has fast converged waveguide superlattices as a waveguide array followed by a trapezoidal slab grating, or plane emitting surface, or plate, or slab grating as the emitter, which avoids uncontrolled coupling and may achieve half wavelength spacing.

It is well known in the technical field that a FOV of 180 degrees can be theoretically achieved by having a waveguide array with a pitch substantially equal to half a wavelength. This is evident from the following equations:

$${k}_{ux} = {n}_{0} k cos ( {Φ}_{0} ) - \frac{2 m π}{Λ} \qquad ( 1 )$$

$${k}_{uy} = {n}_{0} k sin ( {Φ}_{0} ) \qquad ( 2 )$$

$${n}_{0 Δ dsin ( {Φ}_{0} )} + Δ φ = l λ \qquad ( 3 )$$

$$2 {Φ}_{0} = 2 a sin ( \frac{λ}{2 {n}_{0 Δ d}} ) \qquad ( 4 )$$

where kux=k sin θx and kuy=k sin Oy characterize the direction of the wave vector of the diffracted (far) field, φ₀ is the propagating angle of the plane wave in the near-field, k is the wave number in the air, n₀ is the effective refractive index of the emitting surface, such as slab grating, A and m are the pitch and grating order of the slab grating, respectively.

In order to achieve aliasing-free beam steering with 180° FOV in horizontal direction of the far field, the condition of n₀ sin φ₀>1 needs to be satisfied according to Eq.2. Applying this condition to the Eq. 4, it is possible to derive the aliasing-free condition of Δd<λ/2, same as the conventional OPAs based on waveguide grating array, where Δd is the pitch.

Obtaining a waveguide array with low crosstalk and a small pitch such as around a wavelength, or of substantially half a wavelength or less is difficult in practice due to the crosstalk between the different channels.

Only half-wavelength pitch can achieve 180° FOV. However, in all material platforms for optical devices such as silicon, half-wavelength pitch introduces severe crosstalk between adjacent channels, making it difficult to control the phase and amplitude of each channel. In the presently disclosed OPA light is first squeezed in waveguide array with half-wavelength pitch paths but crosstalk is minimized by keeping the coupling length as short as possible. The coupling length is defined as the length of waveguide which has the spacing less than 2 μm from its neighbour. The short coupling length leads to negligible cross-talk according to simulations and actual measurements and experiments.

In the presently disclosed OPA, the crosstalk between the channels of the waveguide array is minimized by keeping the coupling length short. This is not possible in prior art, which is based on waveguide grating arrays and has a long coupling length in order to achieve a large emitting aperture. The waveguide grating array based OPA is therefore limited in their FOV compared to the presently disclosed OPA.

The present inventors have realized that it is possible to achieve a plane or quasi-plane wave just at the output of the waveguide array with a short waveguide array with minimum crosstalk, and that said plane or quasi-plane wave may have an angle φ₀ in the near field, such angle φ₀ selected based on the programmable phase shift in the phase shifter array. The present inventors have further realized that said wave with angle φ₀ in the near field may further be diffracted, or weakly diffracted, and emitted to an emitting angle θ, by an emitting surface, such as a plate grating or grating surface or slab grating, to the far field, achieving a 180 degrees field of view with a low SLL.

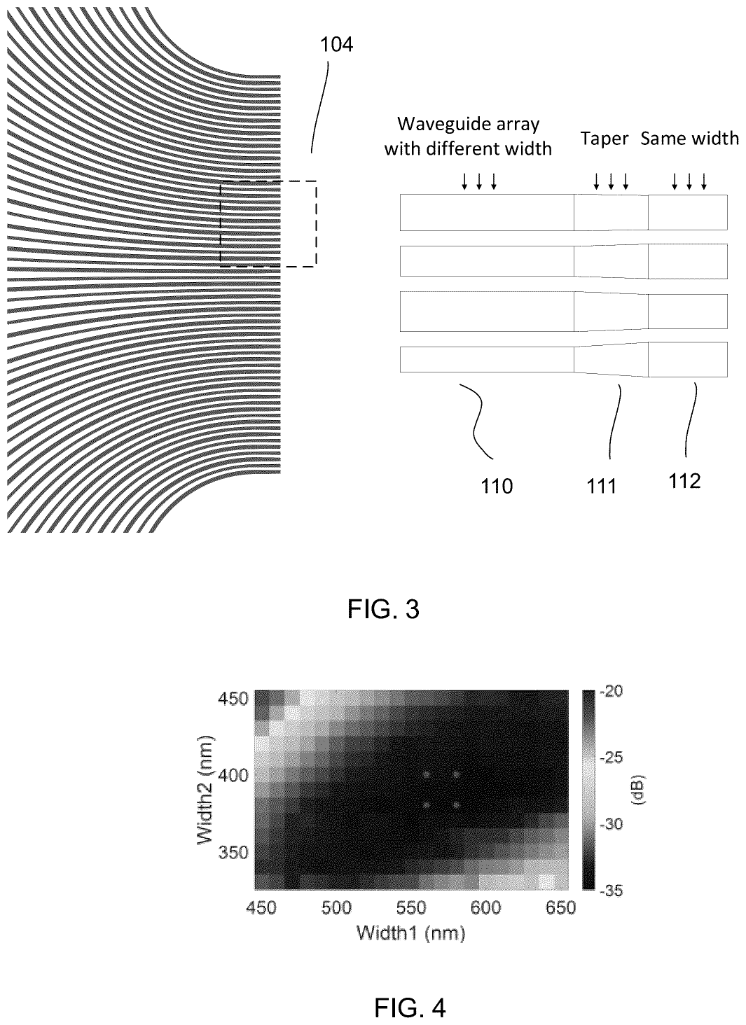

FIG. 3 is showing a diagram of the waveguide array and a diagram of a portion of such waveguide array, with a tapered narrow pitch. The widths of the waveguide are first varied to reduce crosstalk and then tapered (111) to the same width (112) at the output end of the waveguide array.

FIG. 4 is showing the crosstalk in dB between adjacent waveguides in the waveguide array. From FIG. 4 it is clear that the waveguide array design of the presently disclosed OPA has a low cross-talk figure or crosstalk and therefore allows for 180 degrees FOV. The low cross-talk is due to the short length of the waveguide array.

In one embodiment of the presently disclosure, the channels in the waveguide array are waveguide superlattices selected to have a pitch substantially equal to half of the wavelength of the light, and wherein crosstalk between channels in the waveguide array are minimized, among other techniques, by using different widths of the channels, said different widths preferably being chosen among 560, 400, 580, and 380 nm, or other relevant values.

In one embodiment of the presently disclosed OPA, the waveguide array is configured to have a pitch substantially or preferably equal to or small than half-wavelength of the light for a 180 Degrees field of view, or higher value of pitch, that is a pitch larger than half wavelength for a field of view less than 180 degrees.

In one embodiment of the presently disclosed OPA, the waveguide array is configured to have a pitch comprised by substantially one third of the wavelength and substantially a double wavelength, or more preferably a pitch comprised by substantially one fourth of the wavelength and substantially one wavelength, or most preferably a pitch substantially equal to half-wavelength of the light for a 180 degrees field of view, or any other value of pitch that is adapted to realize an optical phased array.

In one embodiment of the presently disclosed OPA the pitch of the waveguide array is not limited to half wavelength but the pitch may be comprised by one third of the wavelength and twice the wavelength, or even larger. The inventors have realized that the proper pitch may be selected according to the specification of the OPA, in particular the field of view.

In one embodiment, the coupling length of the waveguide array is between 52 micrometers and 700 micrometers, or higher value when the number of channels is close to a maximum.

The present inventors have realized that the length of the waveguide array has to be minimized in order to minimize crosstalk between adjacent channels. On the other hand, the minimum length depends on the number of channels, due to the geometry of the waveguide array and the curvature of the waveguides when squeezing them to the narrow pitch output end. The present inventors have further realized that a value of 700 micrometers for the coupling length of the waveguide array, in a 1000 channels OPA is still providing an 180 degrees FOV. The present inventors have further realized that a value of 52 micrometers is providing an 180 degrees FOV in case of 64 channels. The present inventors have altogether realized that an aliasing-free 180 Degrees FOV is achieved by the presently disclosed OPA by combining the half-wavelength spacing (pitch) waveguide array and the emitting surface, such as a trapezoidal slab grating, or plate grating.

In one embodiment of this OPA, the width of each channel at the narrow pitch output end of the waveguide array is tapered to the same width for each channel, for example, to around 450 nm, as shown in FIG. 3.

The tapering at the narrow pitch output end may have the function of avoiding periodical amplitude fluctuation of each channel.

### Emitting Surface

In one embodiment of the present disclosure, the plane emitting surface comprises a trapezoidal slab grating, or a slab grating, or a plate grating, or a combination thereof.

In a further embodiment of the present disclosure, the plane emitting surface is between 0.1 and 30 millimeters, or 1 and 100 millimeters, preferably 4 millimeters long, has a shallow etch depth of between 5 and 15 nm, preferably 10 nm, and has a pitch of between 450 and 650 nm, preferably 560 nm.

In a further embodiment of the present disclosure, the plane emitting surface is formed by a layer of low refractive index material deposited on a silicon substrate and selectively etched.

In one embodiment of the present application, the emitting surface brings the light from the chip into the free space. It may be a shallow-etched plate grating surface and is different from all other emitting designs such as long waveguide gratings or single grating, or end-fire emitting.

### Free Propagation Region

In some cases the plane or quasi-plane wave formed at the output-end of the waveguide array may have higher order diffraction beams. In case of a half-wavelength pitch of the waveguide array, the higher order diffractions do not emit into the far field by the emitting surface.

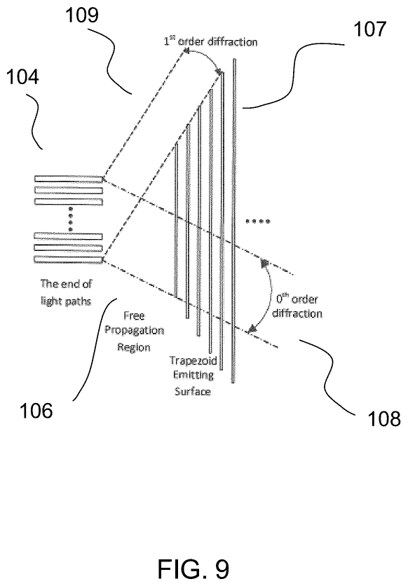

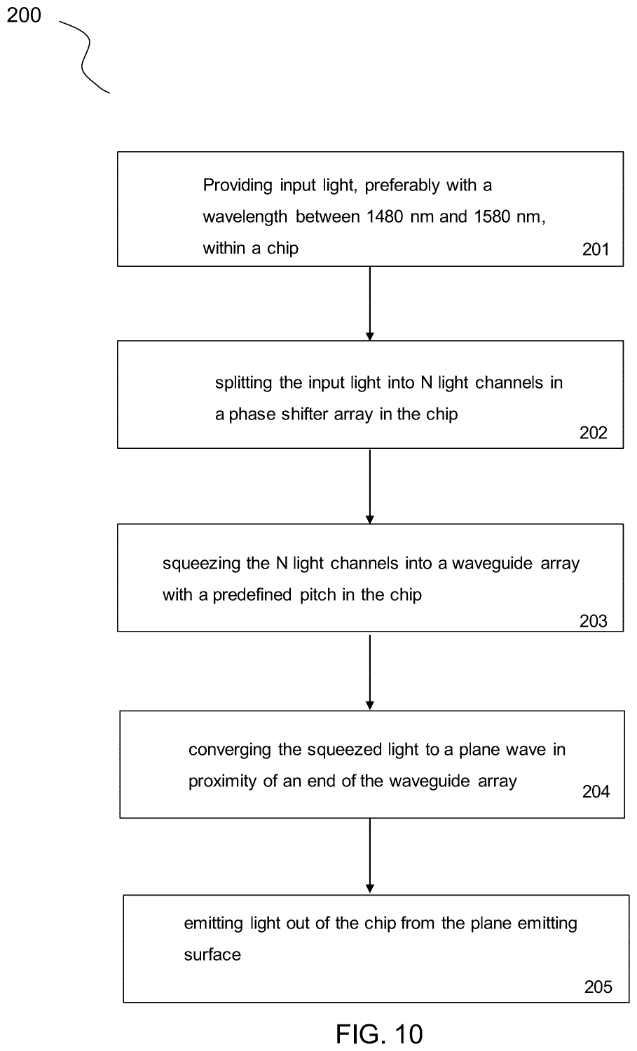

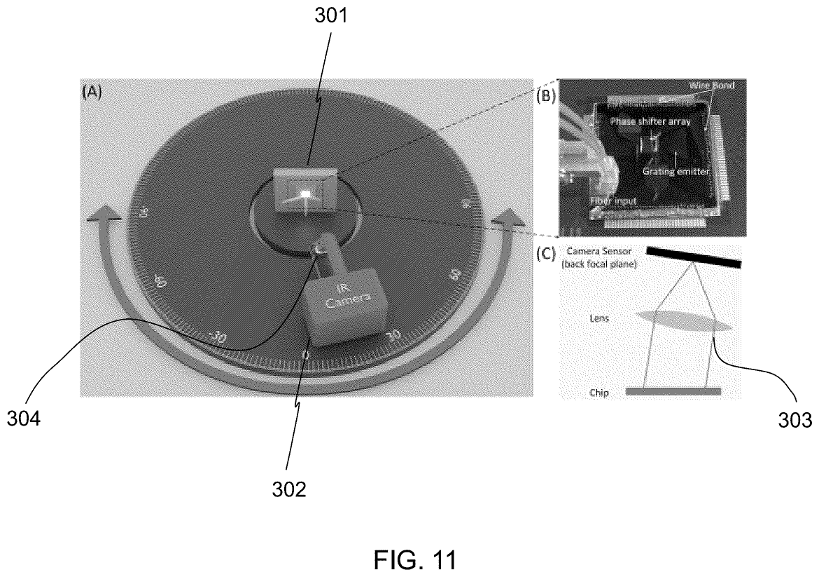

In one embodiment of the presently disclosed OPA, a free propagation region may be used, in combination with a trapezoidal shape of the emitting surface, in order to avoid emission of higher order diffraction beams, if any such beams are formed at the narrow pitch output end of the waveguide array. This is shown in FIG. 9, where the combination of a free propagation region (106) and a trapezoid emitter (108) filters out the higher order diffraction beam (109), and the emitting surface is traversed or passed through only by the main beam (108), or 0 order beam, which is then diffracted to the far field. As the higher order beams do not traverse or pass through the emitting surface, they are not brought or emitted out of the chip to the far field.

In one embodiment of the presently disclosed OPA, the OPA comprises a free propagation region, such as a slab waveguide, positioned between the output end of the waveguide array and the emitting surface, said free propagation region configured for propagating selectively one beam only of the plane wave to the emitting surface with a predefined angle based on the phase tuning in the phase shifter, and propagating other beams, if any, in other directions out of the emitting surface.

### Beam Expansion—General

Beam divergence is an important property of an OPA, in many applications, including for example LiDAR for the automotive industry. A typical way to reduce beam divergence in an OPA is to increase the number of channels according to the following equation:

$$θ = \frac{0.886 * λ}{{N}_{wo expansion} d}$$

where θ is the beam divergence, λ is the wavelength of the light, d is the pitch at the output end of the waveguide array and N_{wo expansion} is the number of channels that would be needed without beam expansion.

The inventors have realized by including a beam expander between the waveguide arrays and the emitter, the beam divergence can be reduced without increasing the number of channels.

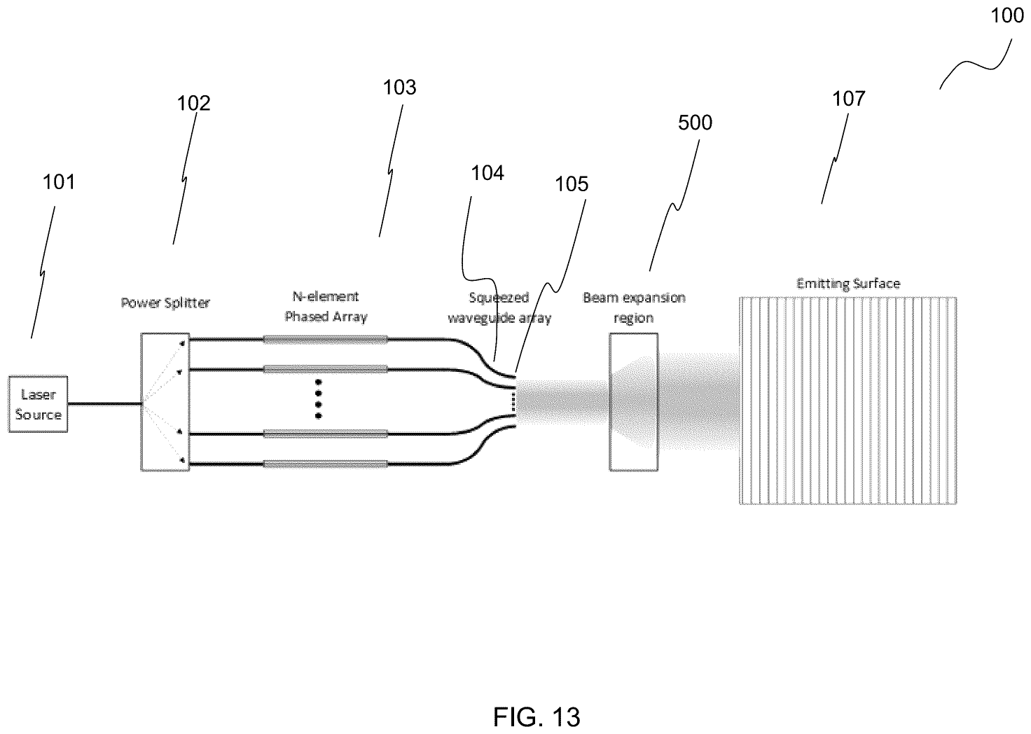

FIG. 13 shows an embodiment of the presently disclosed OPA, comprising a beam expander (500) that expands a first plane wave, from a waveguide array output end (105) to a second expanded wave. The second expanded wave is then emitted as light emittance by the emitter, or emitting surface (107). The beam expander has an expanding ratio a, that is the ratio between the area or the width of the second wave and the area or the width of the first wave.

The following equation can be used to calculate the number of actual channels that are required when using beam expansion between a waveguide array and the emitter, with an expansion ratio a:

$$N = {N}_{w expansion} = \frac{{N}_{wo expans \dot{ι} o n}}{α}$$

where N_{wo expansion} is the number of channels required for a given beam divergence without beam expansion, and N is the number of channels required for a given beam divergence with beam expansion. It is clear from the equation above that the number of channels can be reduced by using an expansion ratio greater than one.

In one embodiment, the presently disclosed OPA comprises a beam expander configured to expand the first plane wave to a second expanded plane wave. In this embodiment the emitter, such as a plate or slab grating, is further configured for transforming the second expanded wave to light emittance with a predefined beam divergence.

The inventors have realized that a beam expander may be implemented in different ways, and especially the inventors have realized that beam expansion can be obtained by use of lenses, in particular a 4f systems that have the ability to focus and expand light, or by use of grating surface, such as oblique grating surfaces, that have the ability to expand and deflect light.

Beam Expansion with Lenses

In one embodiment of the presently disclosed OPA, the beam expander comprises an on-chip optical expander, such as a 4f system, the on-chip beam expander comprising at least two on-chip lenses.

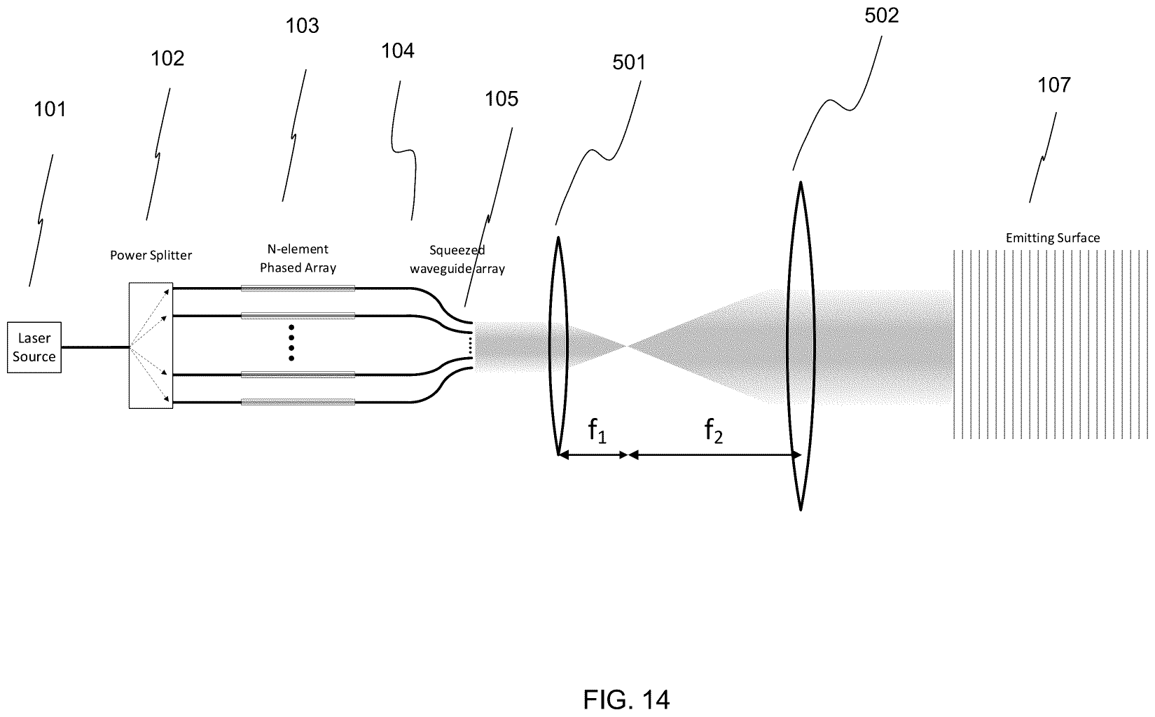

A 4f system which consists of two lenses (501 and 502) between which the distance is the sum of their focal lengths, is shown in FIG. 14. Similar systems are used in free space optics to expand the input beam. The expansion ratio a is the focal length of lens 2 (f2) to the focal length of lens 1 (f1). In this embodiment the 4f system is fabricated on-chip.

In one embodiment, the at least two lenses are two lenses at a distance d from each other equal to the sum of their focal lengths f1 and f2, and wherein the expansion ratio is the ratio between the second focal length and the first focal length.

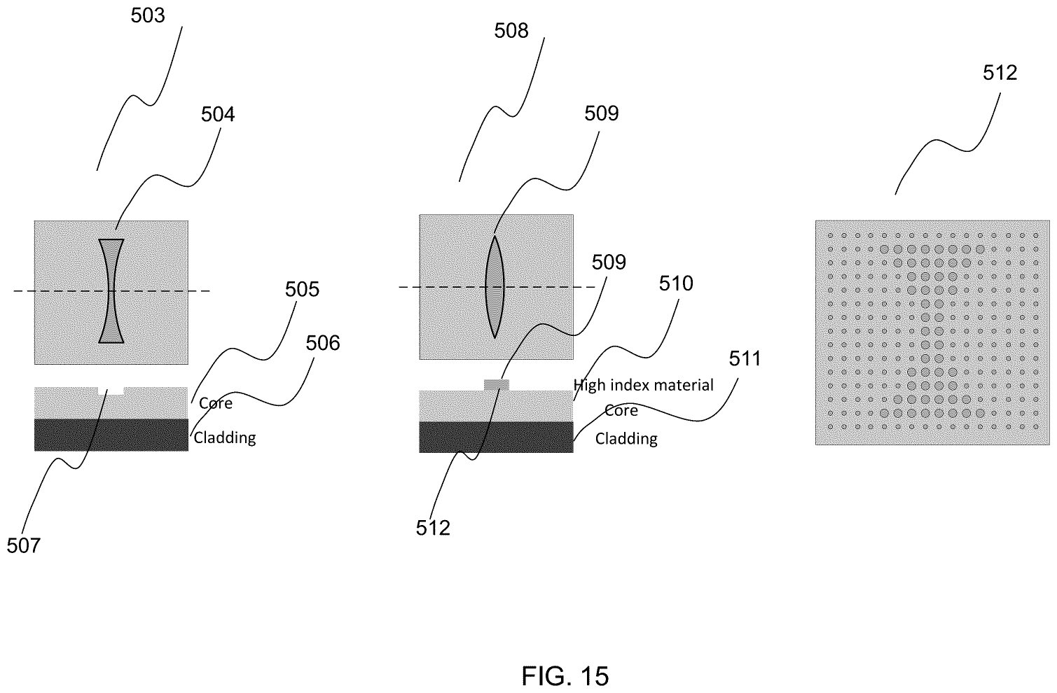

In this embodiment, the 4f system is implemented on chips by fabricating lenses or something alike that have the ability to focus light. This is achieved in several way as shown in FIG. 15. In a first embodiment one of the lenses (503) is obtained by etching a shape of 2D concave lens (504) on the waveguide core layer (505), residing on top and adhering to the cladding layer (506) of the integrated chips. The effective refractive index within the shape is smaller than outside and it has the ability to focus light. In a second embodiment one of the lenses (508) is obtained by depositing a layer of high refractive index material (509) on the waveguide core layer (510) and fabricate it into a shape of convex lens (508). Thus, the effective refractive index within the shape is larger than outside and it has the ability to focus light. In a third embodiment a lens (512) is obtained by engineering the refractive index of the waveguide core layer by subwavelength periodical structures or inverse design approach, as long as it can function as a lens to focus light.

In one embodiment of the present disclosure, at least one of the lenses is a 2-dimensional concave lens obtained by etching a portion of an on-chip core material layer, such as silicon oxide, the core material layer residing on top and adhering to an on-chip cladding material, such as silicon.

In one embodiment of the present disclosure, at least one of the lenses is a 2-dimensional convex lens obtained by depositing a layer of high refractive index material on an on-chip core material, such as silicon oxide.

In one embodiment of the present disclosure, at least one lens comprises subwavelength periodical structures. In this embodiment, subwavelength periodical structures are fabricated on the on-chip core material, such as silicon, by etching and/or by depositing additional material, such as high refractive index material.

Beam Expansion with Grating Surface

In one embodiment of the presently disclosed OPA, the beam expander comprises an on-chip grating surface, such as a slab grating or a two-dimensional photonics crystal based grating, comprising at least one grating, the at least one grating obtained by etching of a low refractive index material deposited on a substrate, such as a silicon substrate, or by other microfabrication means.

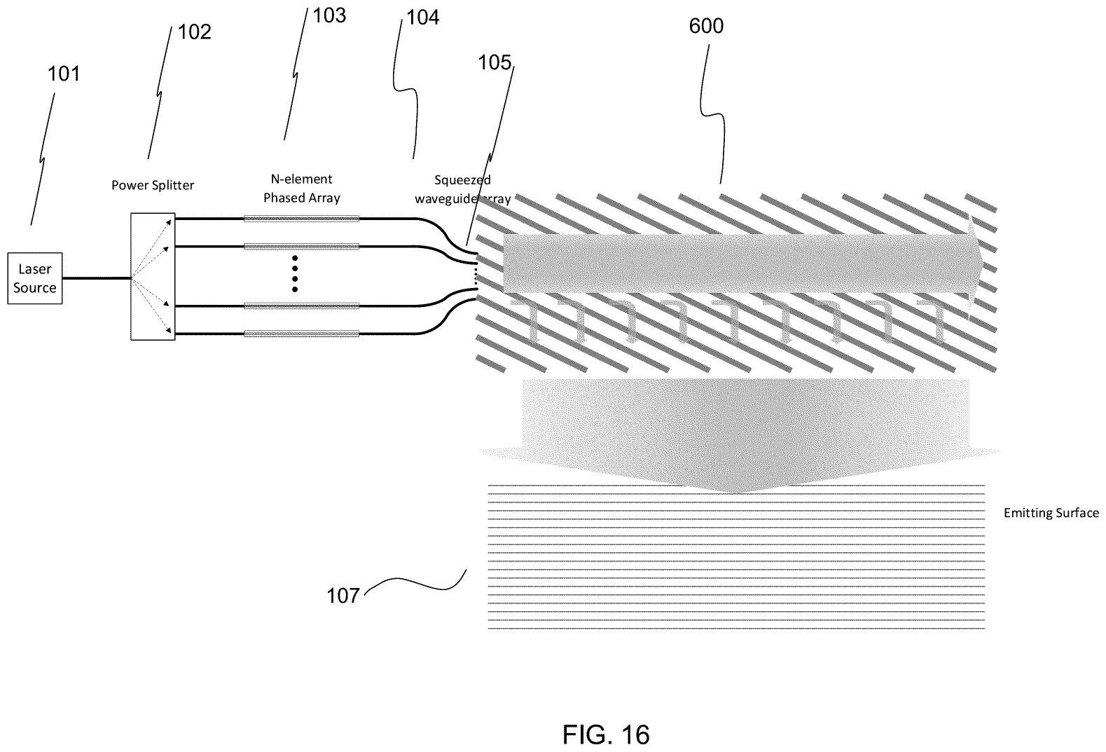

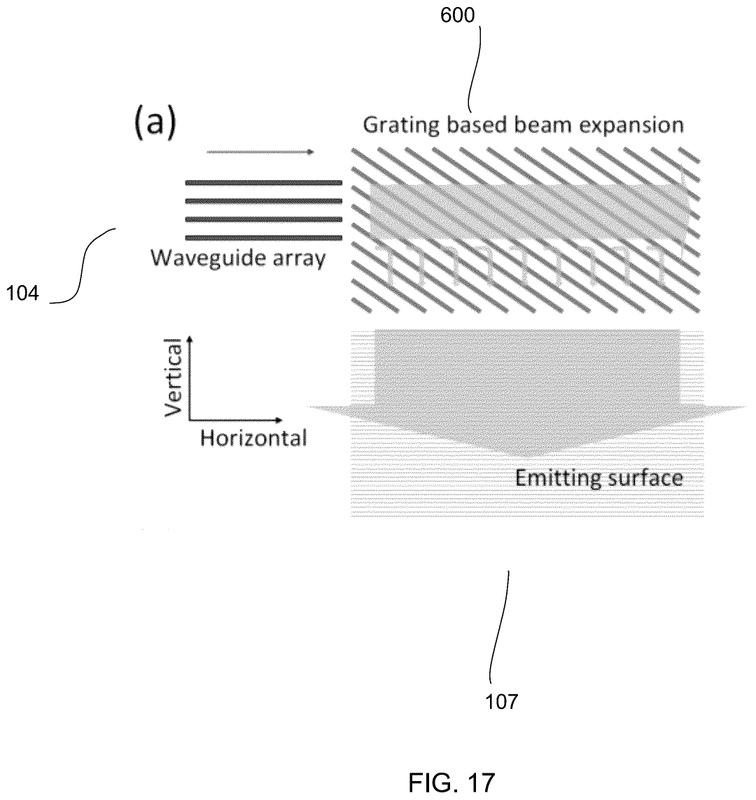

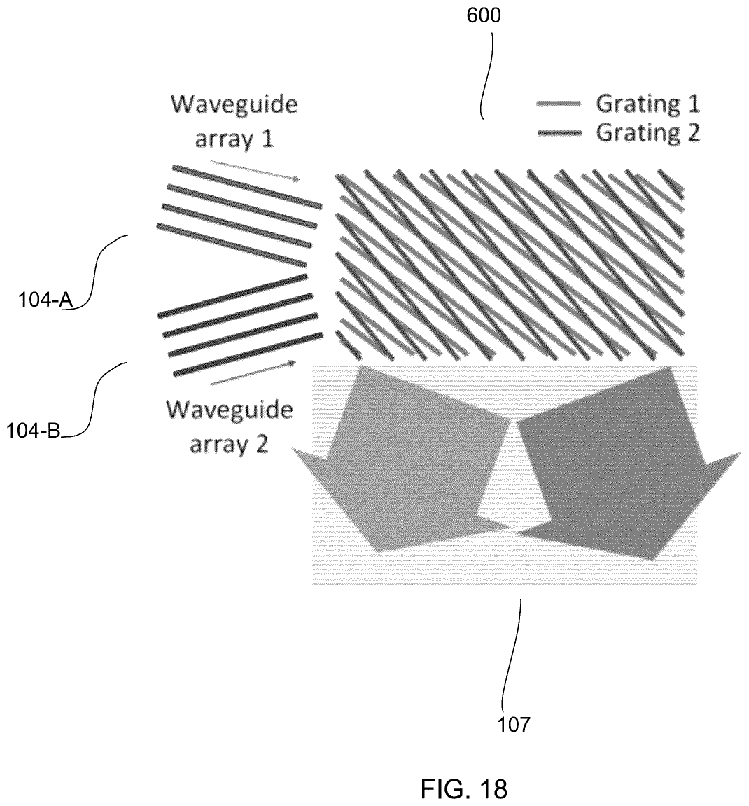

The inventors have realized that grating surfaces, or gratings, especially oblique grating surface or gratings with a proper grating pitch, have the ability to expand and deflect a planar beam. In one embodiment of the present disclosure, a grating is typically oblique with respect to an injection angle of the first planar wave. As shown in FIG. 16, a grating surface based beam expander (600) comprises, in this example, a grating comprising several grating elements, and characterized by a pitch and a grating angle. As shown in FIG. 18, a grating surface based beam expander (600) comprises, in this example, two gratings with different grating angles.

FIG. 16 shows an embodiment of the presently disclosed OPA, where the beam expander (600) comprises a grated surface with an oblique grating with respect to a first injection angle of the first planar wave. The grating surface expands and deflects the first planar wave to a second planar wave, which is then emitted by the emitter (107), such as a slab grating. The injection angle of the first planar wave is the sum of a first component, determined by the phase shift in the phase shifter array, and a second component, determined by the orientation of the waveguide array (104).

As shown in FIG. 16, the beam expander may be a slab grating just like the emitting surface but working with different grating pitch and injection angle. The so constructed beam expander has previously been studied to expand, deflect and shape the beam in the cavity of distributed feedback laser. The grating is also designed to be weak coupled. The inventors have realized that such grated surface, in one embodiment of the presently disclosed OPA, is configured in such a way that the injection beam is deflected into oblique direction in a distributed way, and the beam thus gets expanded. The pitch of the beam expander grating is carefully calculated so that the phase matching happens between the in-plane waves (first planar wave and second planar wave) other than the out-of-plane wave in the free space. The majority of the beam power is coupled into the in-plane deflected wave (second planar wave). The grating-based beam expander (600) combined with other components (laser source, power splitter and phase shifter array are omitted) in OPA is illustrated in FIG. 16. In the embodiment of FIG. 16, the in-plane wave that emits from the horizontal waveguide array (the first planar wave) is deflected into vertical direction and expanded. After the beam expansion, the vertical in-plane wave is diffracted by the emitting surface (107) and goes into out-of-plane direction. The beam steering of the out-plane wave (light emittance) is achieved by tuning the incident in-plane wave from the waveguide array, by using the phase shifter array (103). Since the deflection angle of the grating-based beam expander is related with the incident angle by phase matching condition, βₐ^{→}+β_{d}^{→}=β_{G}^{→}(1) where βᵢ^{→} and β_{d}^{→} are the propagation constant of incident and diffracted wave, β_{G}^{→} is the effective grating vector of which the value is q*2π/Λ (q is the grating order and Λ is the grating pitch) and the direction is parallel to the grating periodical direction. The direction of the expander beam is tuned and thus the out-of-plane wave is tuned. The benefit of using grating as beam expander over other method is its compactness. The expansion ratio of the beam expander depends on the grating coupling strength. The weaker the grating coupling strength is, the longer the first wave emitting from the waveguide array propagates along the horizontal direction, and the larger the size of the aperture is, hence the larger the expansion ratio.

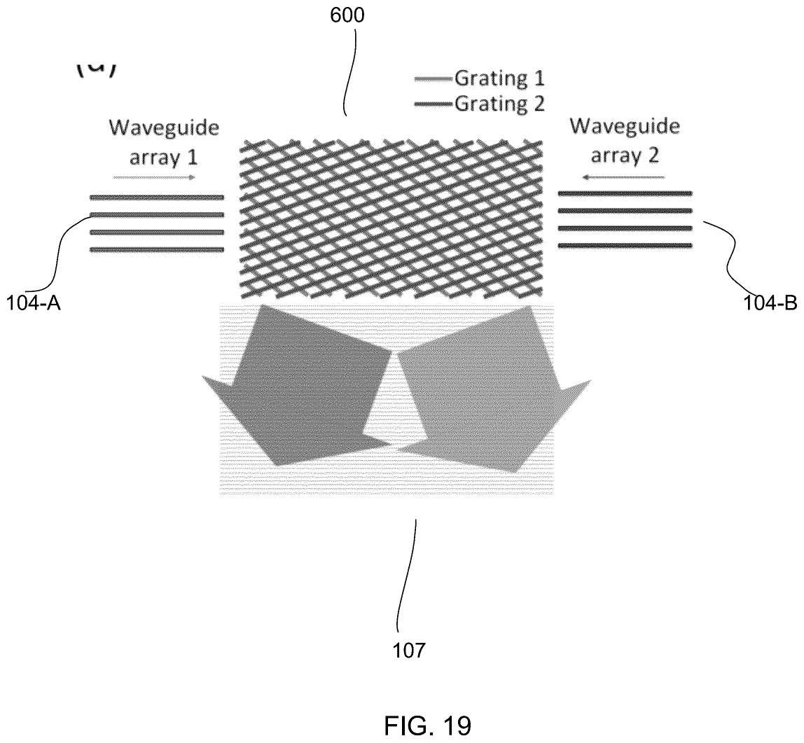

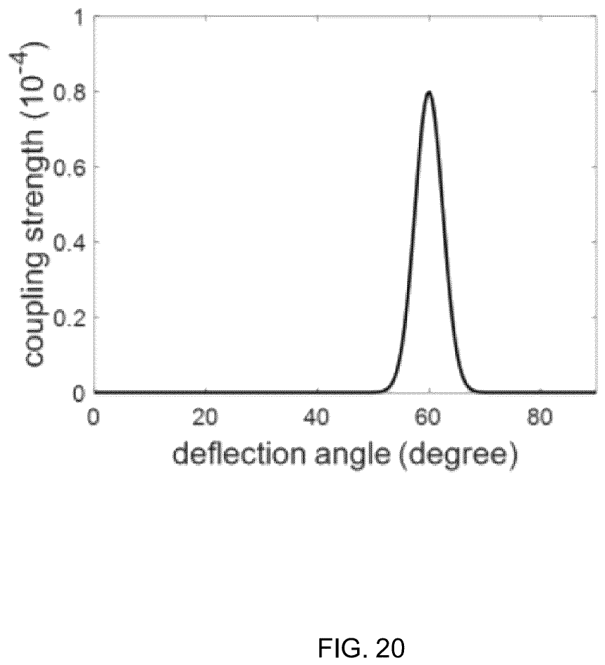

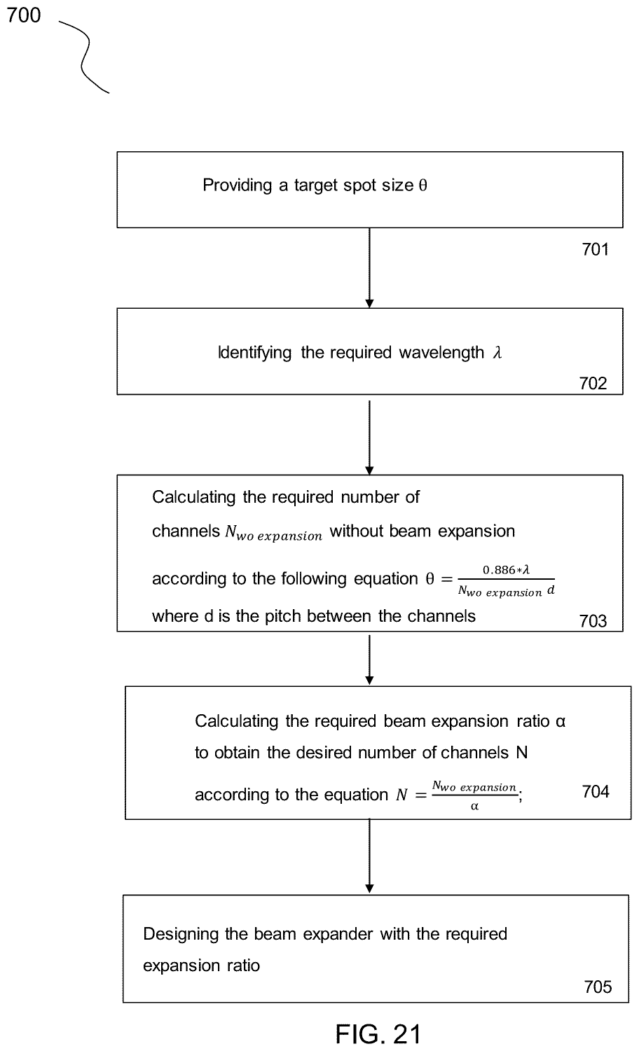

The acceptable incident angle of the beam expander may not cover the range for 180° FOV. FIG. 20 shows the coupling strength of a grating based beam expander in some cases. The coupling strength of the beam expander in this example is significant within a certain range of the deflection angle of 60° with a full width half maximal (FWHM) of 10°, which is not large enough to cover 180° FOV. The inventors have realized that this challenge may be overcome, and 180 degrees FOV may be achieved, by using several waveguide arrays and several gratings with gratings on the grated surface used as a beam expander. FIG. 18 shows an embodiment of the presently disclosed OPA with two waveguide arrays (104-A and 104-B) having different orientations and two gratings on the grated surface, the two gratings having two different grating angles. The orientation and the grating angle are referred to a first direction of the injected (first) planar wave. FIG. 19 is showing another embodiment of the OPA with multiple waveguide arrays and multiple gratings, where the orientation of the waveguide array is different as compared to the embodiment of FIG. 18. The number of waveguide arrays and gratings is not limited to two, even if not shown by the figures, which are only conceptual and describe the working principle.

As shown in FIG. 18 and FIG. 19, large FOV, preferably 180 Degrees FOV is achieved with the following design of this embodiment: the beam expansion region consists of two overlapped gratings, each of which has different grating pitch and corresponding waveguide array with different orientation. According to equation (1), grating with a certain pitch has a determined incident angle with maximal coupling strength and does not affect the propagation of the incident beam far away from this angle. In this way, the two overlapped gratings together with the corresponding waveguide arrays is multiplexed and each one is responsible for a certain range of FOV. The number of overlapped gratings is not necessarily limited to two but may also be more. In FIG. 19 the incident waveguide arrays may be placed at both side of the beam expansion region to make the whole structure more compact. The architectures in FIG. 18 and FIG. 19 may also be combined to fit in more overlapped gratings for wider range of beam steering.

In one embodiment of the presently disclosed OPA, the beam expander comprises an on-chip grating surface, such as a slab grating, comprising at least one grating, the at least one grating obtained by etching of a low refractive index material deposited on a substrate, such as a silicon substrate, or by other microfabrication means.

A grating surface may comprise one or multiple gratings, wherein each grating has several grating elements with same pitch and same grating angle.

In one embodiment of the presently disclosed OPA, each of the gratings is comprising parallel grating elements placed at a predefined grating pitch from each other and oriented at a predefined grating angle relative to a first injection direction of the first plane wave, such that each grating has a different grating angle than any other of the gratings and such that the pitch may be independent, same or different, between each of the gratings.

The grating surface of the disclosed optical phased array may be configured to expand, with a predetermined expansion ratio, and deflect, with a predetermined output angle, the first planar wave incoming at an injection angle with respect to a first injection direction.

In one embodiment of the presently disclosed OPA, an output angle of the second expanded wave with respect to a first injection direction, has a value within a total range of values, obtained by varying the injection angle of the first planar wave, within a range of injection angle values.

In one embodiment of the presently disclosed OPA, the waveguide arrays may have different orientations, each waveguide array configured to form the first planar wave in time multiplexing, that is in such a way that only one first planar wave is formed at each selected waveguide array at a time.

In one embodiment of the presently disclosed OPA, a first planar wave may be formed at the output end of each waveguide arrays in time multiplexing, that is one at a time. In this embodiment each waveguide array is associated with one grating of the grated surface comprised in the beam expander, and each grating expands and deflects only one first planar wave incoming from only the waveguide array associated to the grating.

In one embodiment of the presently disclosed OPA, each one of the gratings expands and deflects the first planar wave incoming from substantially only one of the waveguide arrays, being that a selected waveguide array.

In one embodiment of the presently disclosed OPA, the shifter array is configured to provide a first component of the injection angle of the first planar wave by shifting the phase of the N channels, and the orientation of a selected waveguide array provides a second component of the injection angle of the first planar wave, in such a way that said injection angle of the first planar way is the sum of said first and second component.

In the present disclosure, the injection angle of the first plane wave depends on mainly two factors: the phase shift of the N channels in the phase shifter and the selection of the waveguide. The first component is related to the working principle of the OPA in relation to the function of the phase shifter. The second is more clearly shown if FIGS. 19 and 20, where it appears that a second component of the injection angle is determined by the orientation of a selected waveguide array.

In one embodiment of the present disclosure, the grating surface is formed by a layer of low refractive index material, such as silicon nitride, deposited on a silicon substrate and selectively etched.

An expansion ratio and a deflection angle of the grating may be determined by the grating pitch and the grating order of the grating and/or an injection angle.

The beam divergence of the light emittance of the presently disclosed OPA, may be inversely proportional to a beam-expanding ratio of the beam expander when the number of channels is predetermined, wherein the beam-expanding ratio is the ratio between the area or width of the second expanded planar wave and the area or width of the first planar wave.

In the optical phased array of the present disclosure, a required number of channels N for a target beam divergence θ may be inversely proportional to the beam expansion ratio, and wherein a target beam divergence of 0.01 degrees is obtained with a number of channels N=64.

### Two-Dimensional Photonic Crystal

In one embodiment, the beam expander of the presently disclose OPA comprises a two-dimensional photonic crystal grating, wherein a plurality of photonic crystals are arranged in oblique parallel rows with a first spacing between crystals in the same rows, and a second spacing between consecutive rows.

The rows of photonic crystals may be oblique with respect to an incident angle of an injection light beam, generated at an output end of a waveguide array and directed to the beam expander.

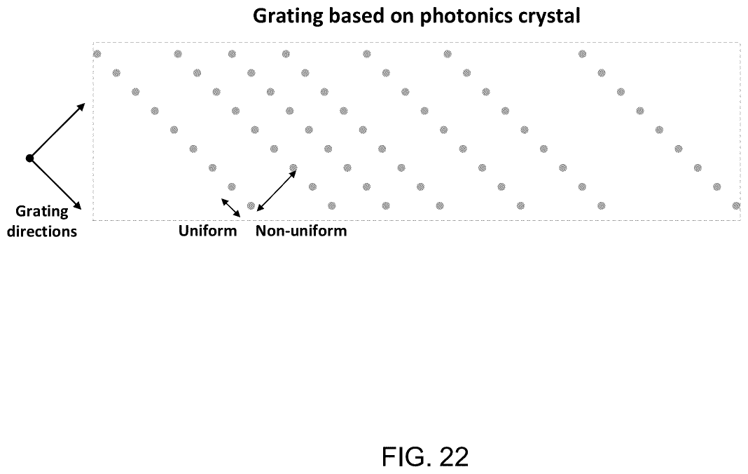

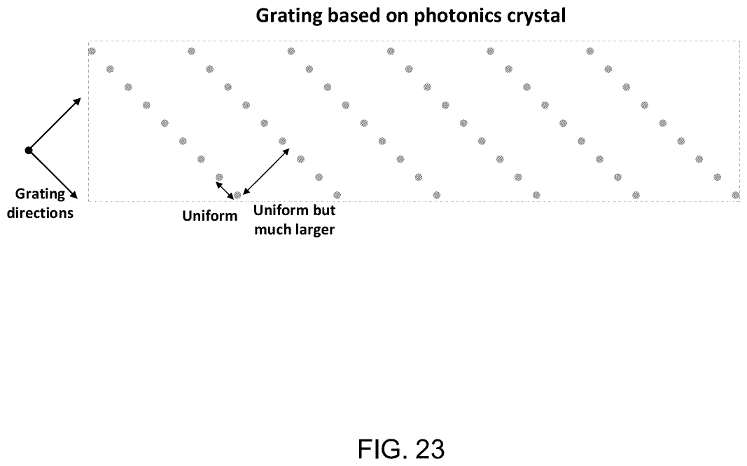

The first spacing may be uniform and the second spacing may be non-uniform, such as random or pseudo-random (FIG. 22), or uniform with much larger spacing than the first one (FIG. 23).

The grating pitch, or spacing, is non-uniform (or relatively large enough) in one dimension (between different rows) so that the deflected angle can be tuned by varying the injection angle of the beam. The grating pitch in the other dimension (within the same row) is uniform and small enough so that the planar beam does not get diffracted into free space during expansion.

The first spacing may be small enough in such a way that an incident light wave does not diffract into open space during expansion and the first spacing may be so small that the photonics crystals in one row may form substantially a stripe.

In the two-dimensional photonics crystal based grating (strip grating can also be considered as two-dimensional photonics crystal based grating except it's continuous in one dimension), if the grating pitch is uniform, there are two phase-matching conditions in each dimension, which cannot be satisfied at the same time if injection angle is varied. This is demonstrated in FIG. 20, which shows the typical coupling strength of a grating based beam expander. The coupling strength in this example is significant only around the deflection angle of 60°, at which both two phase matching condition is satisfied. This is solved by randomizing the grating pitch in one dimension to break the phase-matching condition in this dimension (as show in FIG. 22), or increasing the grating pitch in one dimension to form a quasi-phase-matching condition in this dimension (as show in FIG. 23). In this case, only one phase matching condition in the other dimension needed to be satisfied. For this reason, the two-dimensional photonics crystal based grating may expand and deflect an incident light beam with a coupling strength corresponding to a 180 degree FOV of the optical phased array.

The two-dimensional photonics crystal based grating may be fabricated on chip and obtained by etching of a low refractive index material deposited on a substrate, such as a silicon substrate, or by other microfabrication means. Photonics crystals may consist of holes and/or pillars.

### Examples

In the presently disclosed OPA the achieved beam may be aliasing free over the entire 180 degrees field of view.

The presently disclosed OPA may achieve a spot beam with a beam width of 2.0 Degrees in the horizontal direction at an angle of 0 degrees in the case of 64 channels, and the beam width is 0.08 Degrees in the vertical direction.

FIG. 6 shows the measured far-field optical power of one embodiment of the presently disclosed OPA, over the entire 180° FOV, demonstrating the aliasing-free beam steering in horizontal direction.

FIG. 7 shows, for one embodiment of the presently disclosed OPA, the SLL (blue) and the spot size (red) for the different values of the horizontal angle in the far field: an SLL of <−19 dB is achieved over the entire 180° FOV when the beam is steered from −40° to +40°.

The presently disclosed OPA may achieve 180 Degrees field of view at the same time as a high-quality side lobe level (SLL).

In one embodiment of the present disclosure, a two-dimensional (2D) beam is provided by tuning the wavelength of the light from 1480 nanometers to 1580 nanometers using the disclosed OPA. FIG. 8 is showing an example of an obtained 2D image using the 2D beam.

A measurement set-up for one embodiment of the presently disclosed OPA is shown in FIG. 11, where the presently disclosed OPA is referenced as (301) and an IR (infrared) camera (302), configured to measure and store the intensity of the received near infrared beam, is used together with a system of lenses (303) to measure the far-field and the near-field emission of the OPA chip. A lens (NA=0.42) with the back-focal plane on the infrared camera sensor is used to obtain the far-field image and a telecentric lens assembly is used to obtain the near-field image. The imaging system is rotated along a circle rail in order to measure the entire 1800 FOV.

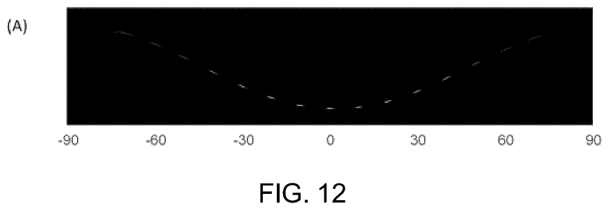

FIG. 12 is showing the spliced image of the measured far-field radiation pattern as a function of the angle in the horizontal direction. The trajectory is a curve since the imaging system rotates along a circular rail.

FIG. 6 shows the measured far-field optical power of one embodiment of the presently disclosed OPA, over the entire 180° FOV, demonstrating the aliasing-free beam steering in horizontal direction.

Also the tuning efficiency of each phase shifter and amplitude distribution of all the channels are measured from the far-field image captured by the setup shown in FIG. 11. In one embodiment of the presently disclosed OPA the tuning efficiencies of the phase shifters are measured to be around 7 mW/π and can be further improved. In order to compensate the phase misalignment of the 64 channels, a gradient descending algorithm is used to calibrate the initial phases and form the main beam in the far field. The GAD of the 64 channels are also measured by tracking the far field intensity variations. In one embodiment of the presently disclosed OPA the amplitude ratio from center to edge of the GAD is measured to be around 7 dB, which is in good agreement with the star coupler design and a trade-off between the SLL and the far-field spot size. Although a higher amplitude ratio can further lower the SLL, it also reduces the effective emitting area due to the low amplitude at the edge.

In the optical phased array of the present disclosure, a target beam divergence of 0.01 Degrees is obtained with a number of channels N=64, with beam expansion.

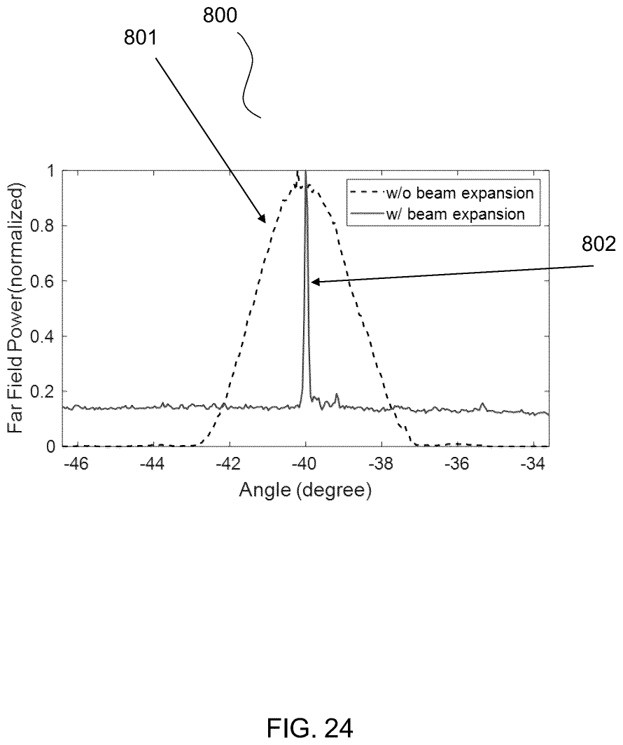

FIG. 24 shows a comparison (800) of an obtained beam divergence or spot size of an embodiment of the presently disclosed OPA, with beam expansion (802) according to an embodiment of the present disclosure and without beam expansion (801). The beam divergence (802) is measured on an embodiment of the presently disclosed OPA, with beam expander comprising a uniform grating based on photonic crystals with a grating pitch of 380 nm and 34 μm in two directions and an oblique angle of 45°. The length of said beam expander along the beam propagation direction is designed to be 2 mm. The measured beam results around −40° angle is shown in FIG. 24 as an example. Compared to the OPA without on-chip expansion indicated by curve (801), the beam size was decreased from 2.6° shown in curve (801) to around 0.09°, shown in curve (802).

### Further Details

A chip integrated optical phased array, comprising:
a phase shifter array having N input light channels and configured for tuning the phase of the N input light channels;
a beam splitter configured for splitting light from a light source into the N input channels of the phase shifter array;
a waveguide array configured for squeezing the phase tuned N light channels to a narrow pitch output end such that the N light channels interfere to form a plane wave at the output end; and
a plane emitting surface configured for transforming the plane wave to light emittance out of the chip with a predefined field of view (FOV).

The optical phased array according to any one of the preceding items, wherein the number of channels N of the phase array is at least 4, more preferably at least 8, even more preferably at least 32, most preferably at least 64.

The optical phased array according to any one of the preceding items, comprising a coupler, such as an apodized grating coupler, for coupling light for a light source into the power splitter or into the phase shifter array, and wherein the coupler preferably is integrated in the chip.

The optical phased array according to any one of the preceding items, wherein the wavelength of the light is between 1480 nm and 1680 nm, such as 1550 nm, or other wavelengths relevant to optical phased arrays, such as visible light, near-infrared or mid-infrared light.

The optical phased array (OPA) according to any one of the preceding items, wherein the OPA comprises a free propagation region, such as a slab waveguide, positioned between the output end of the waveguide array and the emitting surface, said free propagation region configured for propagating selectively one beam only of the plane wave to the emitting surface with a predefined angle based on the phase tuning in the phase shifter, and propagating other beams, if any, in other directions out of the emitting surface.

The optical phased array according to any one of the preceding items, wherein the input channels of the phase shifter array are folded waveguides having variable widths and a pitch, preferably between 0.775 micrometers, such as substantially half wavelength, and 2 micrometers, or one and a half wavelength.

The optical phased array according to any one of the preceding items, wherein channels in the waveguide array are waveguide superlattices selected to have a pitch substantially equal to half of the wavelength of the light, and wherein grating lobes and crosstalk between channels in the waveguide array are minimized by using different widths of the channels, said different widths preferably being chosen among 560, 400, 580, and 380 nm, or other relevant values.

The optical phased array according to any one of the preceding items, wherein the waveguide array is configured to have a pitch substantially equal to half-wavelength of the light for a 180 degrees field of view, or higher value of pitch.

The optical phased array according to any one of the preceding items, wherein the length of the waveguide array is between 52 micrometers and 700 micrometers, or higher value when the number of channels is close to a maximum.

The optical phased array according to any one of the preceding items, wherein the width of each channel at the narrow pitch output end of the waveguide array is tapered to the same width for each channel, for example, to around 450 nm.

The optical phased array according to any one of the preceding items, wherein the phased shifter array, such as a thermo-optical phased array, is configured to shift or tune the phase of each light channel independently.

The optical phased array according to any one of the preceding items, wherein each channel of the phased shifter array is controlled by a controller, such as a digital-to-analog converter (DAC) or a field programmable gate array, configured for allowing arbitrary phase shifts from 0 to 2π radians for each channel.

The optical phased array according to any one of the preceding items, wherein the beam splitter is a 1-to-N splitter, such as a star coupler, or a Y branch array or a cascaded directional coupler.

The optical phased array according to any one of the preceding items, wherein the beam splitter is configured to split the light into N channels according to a Gaussian Amplitude Distribution (GAD) of the light in the N channels, and wherein the center-to-edge GAD ratio preferably is at least 5 dB, more preferably at least 7.5 dB, or set by a requirement of the side lobe level.

The optical phased array according to any one of the preceding items, wherein the plane emitting surface comprises a trapezoidal slab grating, or a slab grating, or a plate grating, or a combination thereof.

The optical phased array according to any one of the preceding items, wherein the plane emitting surface is between 0.1 and 30 millimeters, or between 0.2 and 100 millimeters, preferably 4 millimeters long, has a shallow etch depth of between 5 and 15 nm, preferably 10 nm, and has a pitch of between 450 and 650 nm, preferably 560 nm.

The optical phased array according to any one of the preceding items, wherein the plane emitting surface is formed by a layer of low refractive index material, such as silicon nitride, deposited on a silicon substrate and selectively etched.

The optical phased array according to any one of the preceding items, wherein the chip is a silicon on insulator (SOI) chip and the fabrication of the chip is fully compatible with complementary metal-oxide-semiconductor (CMOS) process or wherein the chip is of other material platforms, such as indium phosphide, silicon nitride, silicon oxide, aluminum nitride or any material platform on which OPA device can be fabricated.

A method for generating a two-dimensional (2D) spot light beam with a 180 degrees horizontal field of view (FOV), the method comprising the steps of:
providing input light, preferably with a wavelength between 1480 nm and 1580 nm, within a chip;
splitting the input light into N light channels in a phase shifter array in the chip;
squeezing the N light channels into a waveguide array with a predefined pitch in the chip;
converging the squeezed light to a plane wave in proximity of an end of the waveguide array; and
emitting light out of the chip from the plane emitting surface, wherein the emitting angle in one direction or dimension of the emitted light is controlled by adjusting the phase in each light channel.

The method of paragraph [00185], wherein the wavelength of the input light is adjusted to obtain a 2D beam.

The method of any of preceding paragraph [00185] to [00186], using the optical phased array of any of preceding paragraphs [00167] to [00184].

1-52. (canceled)

53. A chip integrated optical phased array, comprising:
a phase shifter array having N input light channels and configured for tuning the phase of the N input light channels;
a beam splitter configured for splitting light from a light source into the N input channels of the phase shifter array;
at least one waveguide array configured for squeezing the phase tuned N light channels to at least one output end, such that the N light channels interfere to form a first plane wave at the output end; and
an emitter configured for emitting light out of the chip with a predefined field of view (FOV) and/or with a predefined beam divergence.

54. The optical phased array according to claim 53, wherein the emitter is a plane emitting surface configured for transforming the first plane wave to light emittance out of the chip with a predefined field of view (FOV) and/or with a predefined beam divergence.

55. The optical phased array according to claim 53, wherein the at least one output end has a narrow pitch.

56. The optical phased array according to claim 53, wherein the at least one output end has a pitch of less than one wavelength of the light.

57. The optical phased array according to claim 53, wherein the number of channels N of the phase array is at least 4, or at least 8, or at least 32, or at least 64.

58. The optical phased array according to claim 53, comprising a coupler for coupling light from a light source into the phase shifter array through a power splitter, and wherein the coupler is integrated in the chip

59. The optical phased array according to claim 53, wherein the wavelength of the light is between 1480 nm and 1680 nm, or other wavelengths relevant to optical phased arrays or wherein the wavelength ranges from ultraviolet light, visible light, near infrared light, mid-infrared light to far infrared light.

60. The optical phased array according to claim 53, wherein the OPA comprises a free propagation region positioned between the output end of the waveguide array and the emitting surface, said free propagation region configured for propagating selectively one beam only of the plane wave to the emitting surface with a predefined angle based on the phase tuning in the phase shifter, and propagating other beams, if any, in other directions out of the emitting surface.

61. The optical phased array according to claim 53, wherein the input channels of the phase shifter array are folded waveguides having variable widths and a pitch between 0.775 micrometers, substantially half wavelength, and 2 micrometers, or substantially one and half a wavelength.

62. The optical phased array according to claim 53, wherein channels in the waveguide array are waveguide superlattices selected to have a pitch substantially equal to half of the wavelength of the light, and wherein grating lobes and crosstalk between channels in the waveguide array are minimized by using different widths of the channels.

63. The optical phased array according to claim 53, further comprising a beam expander configured to expand the first plane wave to a second expanded plane wave, and wherein the emitter is further configured for transforming the second expanded wave to light emittance with a predefined beam divergence.

64. The optical phased array according to claim 63, wherein the beam expander comprises an on-chip optical expander the on-chip optical expander comprising at least two on-chip lenses.

65. The optical phased array according to claim 64, wherein the at least two lenses are two lenses at a distance d from each other equal to the sum of their focal lengths f1 and f2, and wherein the expansion ratio is the ratio between the second focal length and the first focal length.

66. The optical phased array according to claim 63, wherein at least one lens comprises subwavelength periodical structures.

67. The optical phased array according to claim 63, wherein the beam expander comprises an on-chip grating surface comprising at least one grating, said at least one grating comprising parallel grating elements placed at a predefined grating pitch from each other and oriented at a predefined grating angle relative to a first injection direction of the first plane wave, such that each grating has a different grating angle than any other of the gratings and such that the pitch may be independent, same or different, between each of the gratings.

68. The optical phased array according to claim 67, wherein the grating surface is configured to expand, with a predetermined expansion ratio, and deflect, with a predetermined output angle, the first planar wave incoming at an injection angle with respect to a first injection direction.

69. The optical phased array according to claim 67, wherein an output angle of the second expanded wave with respect to a first injection direction, has a value within a total range of values, obtained by varying the injection angle of the first planar wave, within a range of injection angle values.

70. The optical phased array according to claim 63, wherein the beam expander comprises an on-chip two-dimensional photonics crystal based grating.

71. A method for generating a two-dimensional (2D) spot light beam with a 180 degrees horizontal field of view (FOV), the method comprising the steps of:
providing input light within a chip;
splitting the input light into N light channels in a phase shifter array in the chip;
squeezing the N light channels into a waveguide array with a predefined pitch in the chip;
converging the squeezed light to a plane wave in proximity of an end of the waveguide array; and
emitting light out of the chip from the plane emitting surface,
wherein the emitting angle in one direction or dimension of the emitted light is controlled by adjusting the phase in each light channel.

72. The method of claim 71, wherein the wavelength of the input light is adjusted to obtain a 2D beam.

73. The method of claim 71, using a chip integrated optical phased array, comprising:
a phase shifter array having N input light channels and configured for tuning the phase of the N input light channels;
a beam splitter configured for splitting light from a light source into the N input channels of the phase shifter array;
at least one waveguide array configured for squeezing the phase tuned N light channels to at least one output end, such that the N light channels interfere to form a first plane wave at the output end; and
an emitter configured for emitting light out of the chip with a predefined field of view (FOV) and/or with a predefined beam divergence.
